(19) United States
(12) Patent Application Publication
(10) Pub. No.: US 2008/0296365 A1
(43) Pub. Date: Dec. 4, 2008

(54) Self Service Device with Manipulation Recognition

(75) Inventor: Dieter Schliebe, Bad Wuennenberg (DE)

Correspondence Address: HARNESS, DICKEY & PIERCE, P.L.C., P.O. BOX 828, BLOOMFIELD HILLS, MI, 48303, US

(73) Assignee: Wincor Nixdorf International GmbH, Paderborn (DE)

(21) Appl. No.: 11/632,893

(22) PCT Filed: Jul. 2, 2005
(86) PCT No.: PCT/DE05/01165

§ 371 Date: Jan. 19, 2007

(30) Foreign Application Priority Data
Jul. 21, 2004 (DE) 10 2004 035 224.0

(51) Int. Cl. G07F 19/00

(52) U.S. Cl. 235/379

(57) ABSTRACT

A self-service device, such as a cash machine, bank statement printer and/or information or transaction terminal, comprising an operator control panel which has a plurality of components is provided with an apparatus (7) for monitoring the weight of at least one of the components of the operator control panel in order to be able to identify manipulations which are carried out on the components.

The invention relates to a self-service device as claimed in the preamble of claim 1, and to a method for identifying manipulation of such a self-service device.

Self-service devices of this type are known in an extremely wide variety of embodiments, for example in the form of cash machines, bank statement printers and also information and/or transaction terminals. They have components, for example operator control panels in the form of keypads, input/dispensing apparatuses and display apparatuses. Input apparatuses are, for example, card readers and money-insertion devices. Dispensing apparatuses serve to dispense banknotes and/or bank statements, receipts and the like. The display apparatuses are, for example, screens and/or displays.

Keypads are used to enter characters in order to carry out the respective action desired by the operator. The keypads may also be integrated in the display as a so-called touchscreen or be located next to, above or beneath the screen.

Cash machines are often a place where manipulation means are fitted with the intention of committing fraud, for example so-called “skimming” or fitting a “Lebanese loop”, and also where structures which the user cannot perceive are added to the keypad and display.

During the process of “skimming”, front structures or attachments are fitted to the components, for example to the card reader, in order to acquire knowledge about the information stored on the respective magnetic and/or chip card and, for example, to forward it by radio. In order to also spy out the PIN number required to operate the machine, a miniature camera containing a data-transmission device is additionally fitted in a region of the self-service machine in such a way that it is possible to identify the entries made on the keypad fields.

In the “Lebanese loop” method, the customer's card is retained in the card reader as a result of manipulative intervention. The customer does not get the card back and leaves the cash machine. The card which is retained in this way is then removed from the card reader by the people who carried out the manipulation.

The object of the invention is to solve the problem of identifying in a simple and reliable manner that mechanical and/or electronic devices are fitted to self-service devices with fraudulent intent.

The object is achieved by the subject matter of claim 1 and by the method as claimed in claim 9.

An apparatus for monitoring a change in position and/or weight of at least one component of an operator control panel on a self-service machine can detect with a high degree of reliability that mechanical and/or electronic components for the purpose of manipulating the self-service machine are fitted.

Furthermore, a method for identifying manipulation of a self-service device is provided, in which method first the weight and/or the position of a component of the operator control panel is determined, the determined value is then compared with a prescribed comparison value and subsequently evaluated. If a deviation from the comparison value is established, a signal for alerting and/or influencing the self-service device is emitted. As a result, it is possible to safely and reliably identify in a simple manner that manipulation attachments are fitted to the self-service machine.

The method is preferably installed and executed by the software in the computer of the self-service device according to the invention.

In this case, it may be advantageous to arrange a central apparatus for manipulation identification within the self-service device and coordinate all components with this central apparatus in order to keep the expenditure on manipulation identification as low as possible.

To this end, it is advantageous if the components are arranged in/on the basic housing in a suitable manner by means of bearing elements, in order to be able to identify a change in weight and or a change in position. The bearing elements are particularly preferably equipped with sensors, or themselves are a constituent part of sensors, in order to thus produce a compact construction.

The signals from the sensors are compared with prescribable comparison values and a distinction is made between operator control-dependent and manipulation-dependent events in an evaluation device.

If an unauthorized person blocks the components, this too is determined in an advantageous further refinement of the invention by means of a checking device which regularly uses an operating device to mechanically act on the components such that any blockage which may be present is found.

The self-service device is preferably equipped with an evaluation device which is provided with a device for influencing the self-service device in order to switch off the self-service device when manipulation is identified.

In this case, it is expedient for an alarm signal to be produced and forwarded, so that superordinate centers are informed of the violation.

In one further refinement, provision is made for the region above the keypad to also be monitored, for example by means of an ultrasound detector in the form of a region-monitoring means, in order to thus advantageously detect items of equipment such as cameras and the like which are retrofitted.

The invention will now be explained using an exemplary embodiment with reference to the attached drawing, in which:

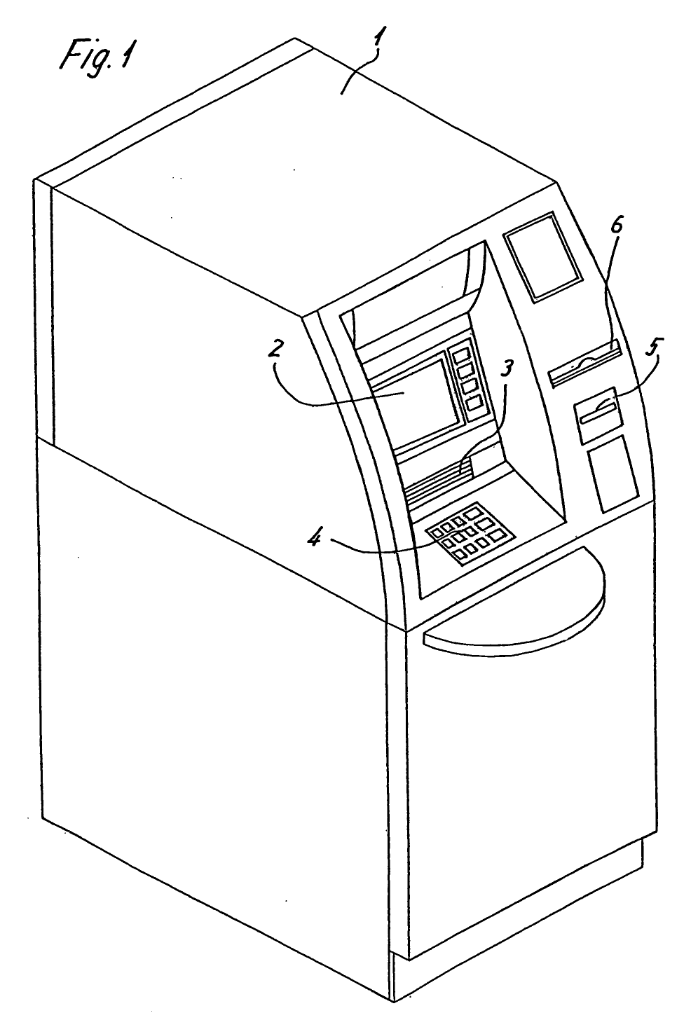

FIG. 1 shows a perspective view of a cash machine; and

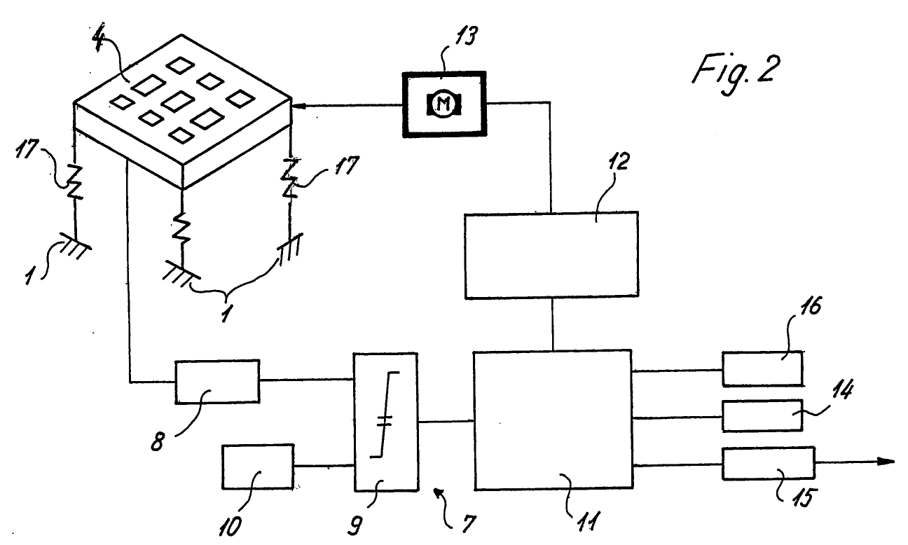

FIG. 2 shows an exemplary block diagram of an apparatus for manipulation identification.

FIG. 1 illustrates, by way of example, a self-service device in the form of a cash machine comprising a basic housing 1.

The basic housing 1 is provided with a display device 2 in the form of a screen, a dispensing device 3 for money, and a keypad 4. Further operating keys may be provided in addition to the display apparatus 2. The region in which these components are located is preferably recessed in relation to the front face of the basic housing 1. In addition, the basic housing 1 has further components, for example a card reader 5 for inserting magnetic/chip cards and, by way of example, a dispensing apparatus 6 for receipts.

The dispensing apparatuses 3 and 6, the keypad 4, the card reader 5 and the screen 2 are also called the operator control panel. They are preferably points at which mechanical and electronic components for manipulating the cash machine with fraudulent intent are fitted, for example keypad attachments, screen attachments, front structures on the card reader 5 and on the cash dispensing compartment 3.

Such attached devices, which are not conspicuous to the customer, change the weight of the operator control panel and one of the components 2 to 6. Manipulation such as this can be identified if the position and/or the weight of the respective component are/is monitored.

Such an exemplary embodiment of an apparatus 7 for monitoring components is shown in a block diagram in FIG. 2.

A component, for example the keypad 4, is placed in the basic housing 1 by means of suitable bearing elements 17. The bearing elements 17 are only schematically illustrated. Provision is made, for example, of spring elements which allow the keypad 4 to shift position on account of the additional weight of an attached manipulation apparatus.

A sensor 8 detects such a shift or is designed such that it can measure the weight of the keypad 4. In one particular embodiment, the sensor 8 is a constituent part of one of the bearing elements 17.

The sensor 8 is, for example, a capacitive travel sensor which can sense small shifts in the position of the keypad 4 on account of an additional weight. Said sensor then generates a signal which is proportional to the weight of the component 4 and is compared with a prescribable comparison value 10 in a comparison device 9. The comparison value 10 may also be an expiration of time if the sensor signal is examined for a specific time period, in order to be able to distinguish between manipulation and regular operation of the keypad 5. For example, the signal which is generated by a continuously present manipulation weight is constant, in contrast to a load created by regular operation which lasts for a limited time.

This distinction is made in an evaluation device 11 which generates a signal which can be forwarded to devices 14, 15 and 16 when manipulation is detected. The device 14 may serve, for example, to directly influence the self-service device 1 by said self-service device being switched off when manipulation is detected. A device 15 may serve to forward an alarm signal to a monitoring center, and the device 16 may be in the form of an alarm device 16.

So that manipulation is not prevented from being detected by the respective manipulated component being jammed or blocked, in order to thus also manipulate weight and/or position identification itself, one preferred embodiment provides a checking device 12 which checks the components for blockages. This is done, for example, by means of an operating device 13 which uses an electromagnet or a motor to influence the respective component 2 to 6 such that a specific change in position and/or weight results. This process is continually repeated at regular intervals.

The devices 9, 11, 12, 14 to 16 may be constituent parts of the software of a computer which is present in the self-service device. However, they may also be of autonomous design.

The invention is not restricted to the exemplary embodiment described above.

Therefore, it is feasible for the sensors 8 used to also be in the form of light barriers, strain gauges and other designs.

Furthermore, the recessed region for the keypad 4 and the display apparatus 2 may be equipped with a region-monitoring means which, for example, uses ultrasound detectors to detect manipulation devices, such as miniature cameras or the like, which were not previously present.

It is also feasible for existing self-service devices to be retrofitted with the inventive apparatuses for manipulation identification.

Walls of the basic housing 1 on which manipulation means are fitted can likewise be mounted such that they are relatively mobile, in order to detect a change in weight. This may also be performed, for example, by means of electric fields or the like.

1-10. (canceled)

11. A self-service device, in particular cash machine, bank statement printer and/or information or transaction terminal, comprising a basic housing and the following components:
at least one or more input/dispensing apparatuses;
at least one keypad; and
at least one display device,
at least one apparatus for monitoring a change in position and/or weight of at least one of the components of an operator control panel for detecting mechanical and/or electronic devices which are fitted to these components and serve the purpose of manipulation with fraudulent intent,
wherein
the monitoring apparatus has a checking device for examining whether the components are blocked or fixed in position, which checking device is equipped with an operating device for mechanically influencing the components, which operating device is designed in such a way that a specific change in position or weight takes place in order to thus identify whether the components are blocked or fixed in position.

12. The self-service device as claimed in claim 11, wherein the components are arranged in/on the basic housing in a manner suitable for this purpose by means of bearing elements.

13. The self-service device as claimed in claim 12, wherein the monitoring apparatus has at least one sensor for sensing changes in position and/or weight of the at least one component.

14. The self-service device as claimed in claim 12, wherein for monitoring purposes, the monitoring apparatus has a comparison device for comparing signals from a respective sensor with prescribable comparison values and/or patterns.

15. The self-service device as claimed in claim 13, wherein for monitoring purposes, the monitoring apparatus has a comparison device for comparing signals from a respective sensor with prescribable comparison values and/or patterns.

16. The self-service device as claimed in claim 11, wherein for monitoring purposes, the monitoring apparatus has an evaluation device which is connected to a device for influencing the self-service device and/or to a device for forwarding messages and/or to an alarm device.

17. The self-service device as claimed in claim 11, wherein at least one of the bearing elements of one of the components is equipped with a sensor or is a constituent part of a sensor.
